(19) United States
(12) Patent Application Publication
(10) Pub. No.: US 2011/0193970 A1
(43) Pub. Date: Aug. 11, 2011

(54) Reducing Jitter in a Recovered Data Stream Clock of a Video DisplayPort Receiver

(75) Inventor: Ning Zhu, San Jose, CA (US)

(73) Assignee: ANALOGIX SEMICONDUCTOR, INC., Santa Clara, CA (US)

(21) Appl. No.: 13/012,986

(22) Filed: Jan. 25, 2011

Related U.S. Application Data
(60) Provisional application No. 61/337,697, filed on Feb. 11, 2010.

(51) Int. Cl. H04N 17/00

(52) U.S. Cl. 348/180; 348/E17.001

(57) ABSTRACT

The system and method, applicable to video display port applications, reduces the jitter in a regenerated data stream clock by using a first-in first-out (FIFO) storage memory to average the variations thereto. The method comprises loading the data extracted from data packets, received over a high speed connection, into the FIFO and running the application using the data in the FIFO. An initial frequency value of the stream clock Fvid is generated from the link clock Flink. Two integer values received over the link, M and N, that establishes a relationship between Flink and Fvid, are used to initiate recovery of Fvid. Lower and upper limits are set for data in the FIFO and the value of Fvid is adjusted to keep the level of data stored in the FIFO within these limits. Accordingly, variations of Fvid are averaged over the limits of the FIFO, thereby reducing the jitter.

### CROSS-REFERENCE TO RELATED APPLICATIONS

This application claims the benefit of U.S. Provisional Patent Application No. 61/337,697 filed Feb. 11, 2010.

### BACKGROUND OF THE INVENTION

1. Field of the Invention

The invention generally relates to high speed data transmission using high speed links, and specifically to improving the quality of reception of audio and video transmitted over high speed links by reducing the jitter at the receiver due to fast changing stream clock.

2. Prior Art

When video and audio data are packetized and sent from a transmitter to a receiver across a high speed link, the data packets are combined with buffer packets, control and other instruction packets. (The buffer packets are filler packets when blanking information etc are present in the video stream). The video stream clock frequency at the transmitter, henceforth referred to as video clock, is Fvid, and the audio stream clock frequency, henceforth referred to as audio clock, is Faud. During the transmission and reception of a video stream only a link clock having a frequency Flink, henceforth referred as link clock, is used over the high speed link. The values of Fvid and Faud vary to adjust for the packet count containing video data across the link. The transmitted packets on the link include the data packets, associated control and special instruction packets and buffer packets when needed.

Typical values of clocks in the display port transmit-receive system for the Fvid ˜2.7 GHz or 1.6 GHz. The lower frequency Flink used for transmitting the packed data has values close to 1/10^{th} of Fvid. The value of Flink is hence 270 MHz or 162 MHz respectively. The typical frequencies for Faud are 32 KHz, 44.1 KHz, 48 KHz, 88.2 KHz, 96 KHz, 176.4 KHz or 192 KHz. Since the packed data stream consists of video and audio packets in addition to control and special instruction packets and only a fixed packet rate is available across the link, Fvid and Faud at the transmitter change to enable sufficient data to be packed within an available transmission period. In the prior art receivers it is necessary to recover the Fvid and Faud, used in the transmitter, to enable proper unpacking and processing of the packets of data. To enable the recovery of the stream clocks, two 24 bit integer values M and N, with relationship to Flink are used, one set for the Fvid recovery and another for the Faud recovery. The relationship between the link clock Flink and the stream clock Fvid or Faud can be expressed as:

Fvid=(Mvid/Nvid)×Flink and

Faud=(Maud/Naud)×Flink

Though the Mvid and Nvid values are both variables, in a typical system, for ease of operation and transmission, the value of Mvid is made variable while the value of Nvid is kept constant for a transmission. The Nvid and Naud values are transmitted with the data stream initially and then only intermittently, to enable set up and checking. The Mvid and Maud values are transmitted to the receiver at intervals that are close as possible to take care of the variations in the Fvid and Faud. As a typical example this may be at the end of a set of data comprising a video line. It is difficult to have the integers continuously follow the variations of clocks at the receiver as they are only transmitted at definite intervals and are not a continuously received at the receiver. This can result in jitter in the recovered clock.

FIG. 1 shows a typical prior art clock recovery system 100 using the M and N values received via the link, used to modify the feedback of the PLL to regenerate the clock in the receiver. The reference clock 101 is either derived from the link clock Flink or is the same as Flink used to transfer packets on the link. This clock, extracted from the link, is used as reference input to the frequency and phase detector 102. The output of detector 103 is processed through the pass filter 103 and is used as input to a charge pump 104. The output of the charge pump is used to drive the voltage controlled oscillator 105. A divide by ‘n’ circuit 106 is used to generate a feedback that is fed back to the frequency and phase detector 102 to ensure frequency tracking. The recovered integer values M and N 108 received via the link are used in a ratio modulator 107 to generate an input to the frequency divider 106 that modifies the feedback to ensure that the recovered video clock output 110 is the stream clock frequency.

In a high speed transmit/receive system, as the data stream clock is continuously varying, there is need for high speed response to the clock changes in the recovery block. In addition the current link transmission standard for display port system link is spread spectrum clocking. The unpredictable nature of the variations in clock frequency superimposed on the variations due to spread spectrum results in large variations in the recovered values of Fvid and Faud resulting in large jitter in the recovered clock and hence the output of the video and audio streams. In a video analog output system this jitter can impact the quality of the output. Audio is also similarly impacted by the jitter present in the recovered stream clock.

It would hence be useful to have a system and method thereto which can reduce the jitter generated when clocks are recovered from the received packet stream using Flink for use in data processing at the receiver.

### BRIEF DESCRIPTION OF THE DRAWINGS

FIG. 1 is a block diagram of prior art video clock recovery circuit.

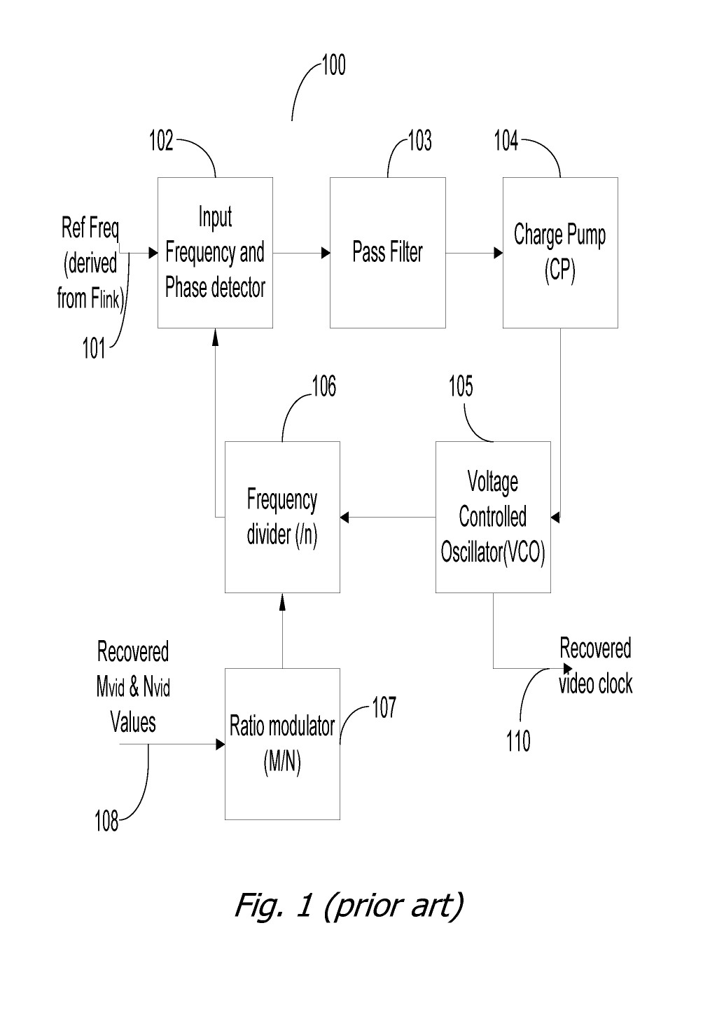

FIG. 2 is an exemplary and non-limiting block diagram of a system implementing the disclosed invention.

FIG. 3 is an exemplary and non limiting flowchart of the method used for jitter reduction.

### DETAILED DESCRIPTION OF THE PREFERRED EMBODIMENTS

The system and method, applicable to a video display port application reduces the jitter in a regenerated data stream clock by using a first-in first-out (FIFO) storage memory to average the variations thereto. The method comprises loading the data extracted from data packets, received over a high speed connection, into the FIFO and running the application using the data in the FIFO. An initial frequency value of the stream clock Fvid is generated from the link clock Flink. Two integer values received over the link, M and N, that establish a relationship between Flink and Fvid, are used to initiate recovery of Fvid. Lower and upper limits are set for data in the FIFO and the value of Fvid is adjusted, by adjusting the values of the integers M and N, to keep the level of data stored in the FIFO within these limits. Accordingly, variations of Fvid are averaged over the limits of the FIFO thereby reducing the jitter.

The exemplary and non-limiting system and method thereto use a first-in first-out (FIFO) storage memory to average the variations of the regenerated data stream clock in a video display port application. The method comprises loading the data extracted from data packets received over a high speed connection into a FIFO and running the application using the data in the FIFO. An initial value of the stream clock Fvid is generated from the link clock Flink. The two integer values received over the link M and N that establishes the initial relationship between Flink and Fvid are used to initiate recovery of Fvid. Lower and upper limits are set for data in the FIFO and the value of Fvid generated is adjusted, to keep the level of data stored in the FIFO within these limits. This method hence averages the variations of Fvid over the limits of the FIFO, thereby reducing the jitter.

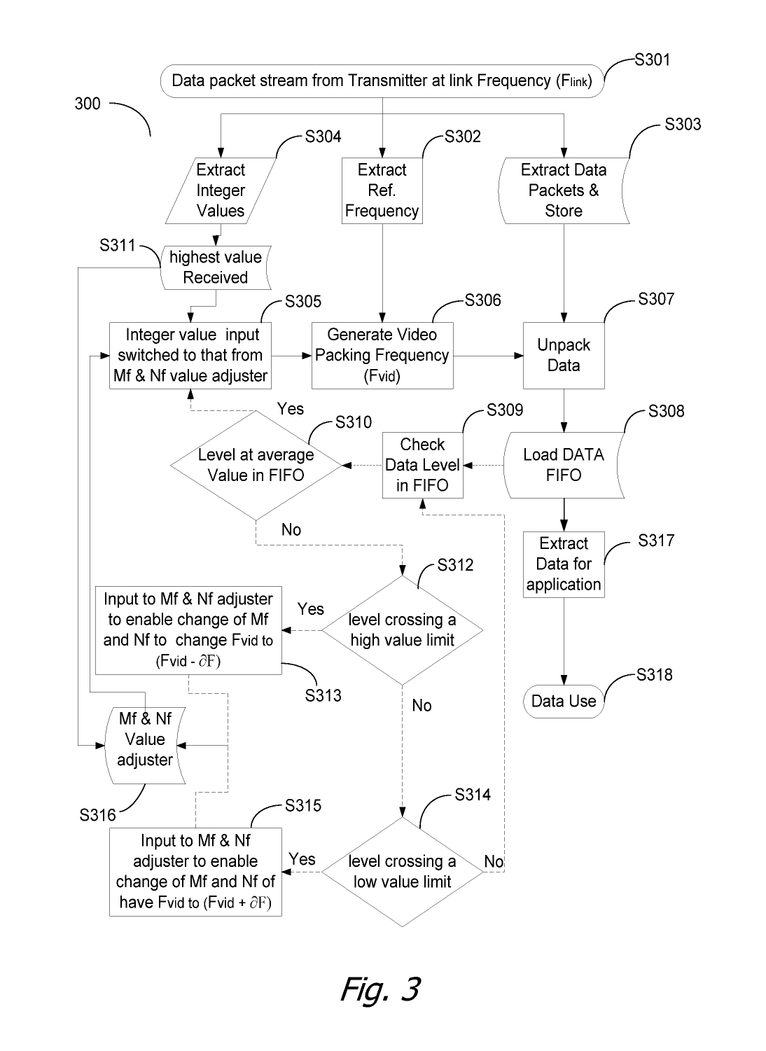

FIG. 3 is an exemplary and non limiting flow chart of one implementation of the method. During transmission and reception of a video data stream in the display port system the data and control information are transmitted as packets over a high speed link using spread spectrum. The link clock Flink is different from the frequency of the data video stream clock Fvid and audio stream clock Faud used at the transmitter, but has a relationship defined by two transmitted integers Mvid and Nvid for video and Maud and Naud for audio data as described earlier. Recovering the Fvid and Faud from the Flink using these received integers, transmitted intermittently over the link, produce high jitter and hence quality degradation due to the continuous varying nature of Fvid and Faud at the transmitter. The current invention disclosed is intended to reduce the jitter at the receiver due to the recovered clocks. The invention eliminates the need for use of the integers transmitted, after an initial value is received by the clock recovery system of the invention, at the receiver, for recovery of the stream clocks. A FIFO is used as data packet store to average the variations in each stream clock.

The exemplary and non-limiting method and system are explained in more detail using the recovery process for Video stream clock Fvid. The same process can be used to extract the audio stream clock Faud.

The initially transmitted integer values Mvid and Nvid are used in the clock recovery circuit 100, to extract an initial value of the stream clock Fvid from the link clock Flink. Typically the extracted Flink is used as the reference clock. The data packets stripped from the control and special instruction packets are unpacked and fed into a FIFO data store. The FIFO is monitored for a multiple high levels of data fill and similarly for low levels of data fill. As the data gets stored in the FIFO and processed from the FIFO, if the level of data stored falls below a monitored low level then the frequency value of the clock Fvid is adjusted up by a value equal to δf thereby increasing the extraction and unpacking of the packets. This increase is done for each monitored level below the mean value of the FIFO to bring up the dropping level of data in the FIFO. Similarly if the stored data level starts to increase in the FIFO and goes above a monitored high level, the frequency Fvid is decreased by a value δf for each monitored level to reduce the speed of unpacking and hence reduce the level of data stored in the FIFO to the average value.

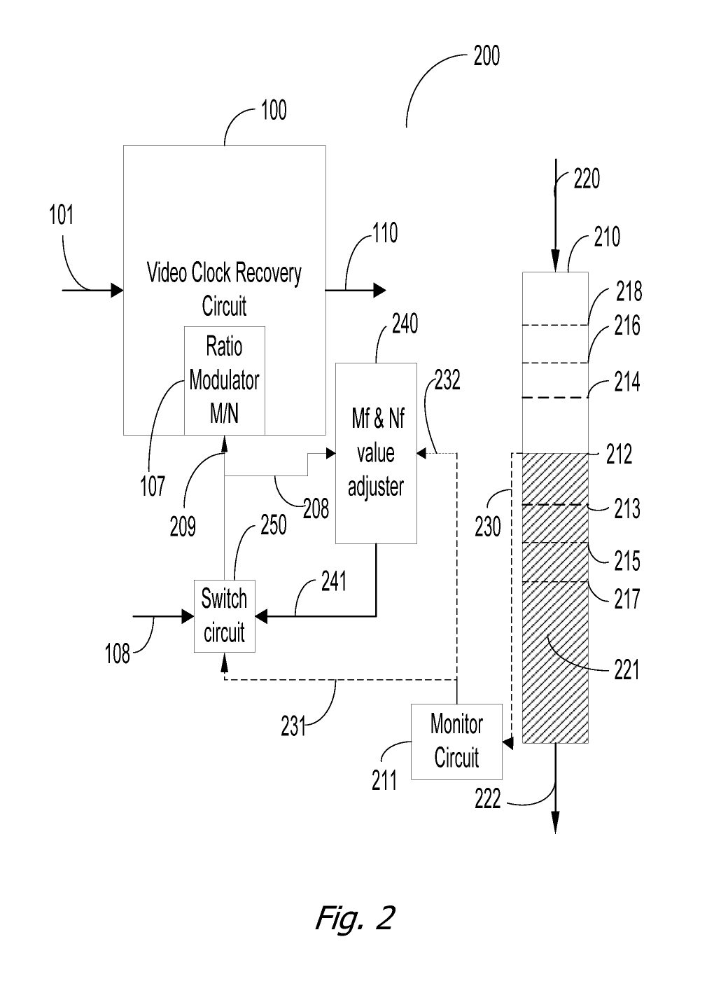

FIG. 2 is an exemplary and non-limiting block diagram implementation of a system 200 enabled implementing the disclosed method. The system 200 has a video clock recovery circuit 100 which has a reference input 101 derived from the link clock Flink and a Ratio modulator M/N 107 that is used to modulate the output frequency 110. The value of the Mvid and Nvid received over the link 108 is fed into a switch circuit 250 based on an input 209. The switch circuit has a second input fed from an Mf and Nf value adjuster circuit 240. The Mf & Nf value adjuster 240 is also fed the current value of the Mvid and Nvid being used via an input 208. A FIFO 210 is provided to store the video data received. It has a mean value set 212 and low incremental response levels 213, 215 and 217 as well as high incremental response levels 214, 216 and 218. Though multiple incremental response levels are shown that enable further smoothing of the output clock, the response levels necessary for this method to function are at least one on the high end and one on the low end. The data input is 220 and the data output from the FIFO is 222. The stored data 221 is indicated by the shaded region. The data level 221 in the FIFO 210 is monitored by a monitor circuit 211 via a control link 230. A control link 232 from the monitor circuit 211 feeds the integer value adjuster, i.e., the Mf &Nf value adjuster 240. A second link 231 is used to switch the input of Mvid and Nvid 209 to the ratio modulator M/N 107 to the output from Mf & Nf value adjuster 240, once the level of data in the FIFO has initially reached a mean value level 212 within the FIFO. Once the initial data value 212 is reached, the monitor circuit 211 continuously monitors the level of data in the FIFO 210 to detect any high level 214, 216, 218 or low level 213, 215, 217 crossing of the data in the FIFO. The Fvid value is kept constant as long as the data level remains within the levels 213 to 214 or until it crosses any of the other levels.

If the level of data stored 221 increases due to the need for data by the receiver is less than the unpacked data, it causes the data stored to increase and cross the first high monitor level 214. The monitor circuit passes the information to the Mf & Nf value adjuster 240 to change the value of the received and saved Mvid, (saved as Mf), and Nvid, (saved as Nf), fed through the link 241, to the switch circuit 250 and hence to the ratio modulator 107 through the connection 209 to decrease the Fvid value by δf such that

Fvid=Fvid−δf.

If the data stored 221 still increases and crosses the second high threshold 216, the value of Fvid is further adjusted by another δf and so on, the reduction to the Fvid being implemented only when the stored data 221 value cross a new high threshold. A lower value of Fvid so achieved reduces the unpacking and loading speed of data 220 into the FIFO 210 and tends to reduce the level of the stored data 221 in the FIFO 210.

Similarly if the data value crosses the low threshold 213, the value of the Fvid is lower than necessary and hence it is increased by a value of δf providing an Fvid value

Fvid=Fvid+δf

enabling the data flow 220 into the FIFO 210 to increase. This frequency increase is repeated for each of the additional low monitoring threshold levels 215 and 217. The higher value of Fvid allows the data level in the FIFO 210 to increase.

FIG. 3 is an exemplary and non limiting flowchart of an implementation of the method as explained below:

receiving the data and control as packetized data over the link connection from the transmitter at a link frequency is Flink. Two integers Mvid and Nvid 108 correlating the packing frequency Fvid to Flink are also transmitted over the link connection (S301);

recovering and regenerating Fvid or a frequency using the Flink, as a reference clock 101 for use in a video clock recovery circuit 100 (S302);

extracting Packet Data and storing the same for unpacking (S303)

receiving the values of the two integers Mvid and Nvid 108, transmitted on the link connection at the receiver (S304);

saving the highest value of the received integers Mvid (as Mf) and Nvid (as Nf) 108 for use in initial re-generation of Fvid 110 (S311);

using the saved integers Mvid and Nvid, to provide an initial feedback input 209 to the video clock recovery circuit 100 to generate the instantaneous value of the clock frequency Fvid 110 (S306);

loading the initial value of the received Mvid and Nvid 108 into the Mf and Nf value adjuster circuit 240 as its initial value (S316);

using the instantaneous value of the regenerated packing frequency Fvid 110 to unpack the data from the packets received (S307);

loading the unpacked data 220 into a FIFO 210 with established sense capability for average data level 212, low data levels 213, 215 or 217, and high data levels. 214, 216, or 218 (S308);

sensing of the respective data levels using a monitor circuit 211 (S309);

checking the data level to find if it has initially reached the average data value 212 (S310);

enabling a switching signal 231 to a switch 250 when the data level first reaches the average value 212 in the FIFO 210, enabling the feedback input 209 to the video clock recovery circuit 100 to switched from the received Mvid and Nvid values 108 to the Mf and Nf values provided through link 241 from the Mf & Nf value adjuster circuit 240 (S316);

continuing checking the data level to see if it is crossing a high value limit; (S312); and if it has then

generating an input to the Mf & Nf adjuster circuit to adjust the Mf and Nf values to reduce the re-generated frequency value of Fvid, such that Fvid=Fvid−δF (S313); if not then,

checking the data level to see if it has crossed a low value limit; (S314); and if it has then

generating a feedback to the Mf & Nf adjuster circuit to increase the re-generated frequency value of Fvid, such that Fvid=Fvid+δF (S314); if not then,

retaining the value of the Mf and Nf same and continue checking the data level in the Fifo (S309);

extracting the data 222 is extracted from the FIFO 210 for further processing and display (S317);

continuously using the extracted data 22 for the display application (S318).

This exemplary and non-limiting flow described allows the feedback generated and hence the Fvid 110 to remain stable till the data in the FIFO crosses a high data level 214, 216 or 218 or a low data level 213, 215 or 217, at which time the monitor circuit 211 generates a signal corresponding to the level and sends it 232 to the Mf and Nf value adjuster circuit 240. This enables the adjustment of the value of the integers Mf and Nf 241 by the Mf and Nf adjuster circuit 240. The change in feedback to the ratio modulator 107 in the clock recovery circuit 100 allows the regenerated Fvid 110 to change. Increasing the value of Fvid 110 if the stored data value 221 crosses a low data level 213, 215, or 217, increases the unpacking speed to increase the rate of data 220 loading into the FIFO 210. Alternately, decreasing the value of Fvid 110 if the data level 221 crossed a high data level 214, 216 or 218 reduces the unpacking speed to reduce the data 220 loading into the FIFO 210.

This method and circuit hence limit the change in the frequency of Fvid 110 from instantaneous high speed response to the received Mvid and Nvid 108 value from the link 108, creating high jitter, to a more gradual average change of the Fvid 110 based on the fill levels 213 to 218 of the FIFO 210. This lower rate of change of Fvid reduces the jitter in Fvid and hence the degradation of quality of the video stream. The stored data 221 also allows the slow changing Fvid 110 to provide for a continuous fixed bit-rate buffered output stream of data 222 from the FIFO 210 even when the unpacking and processing is slower than the output flow of data 222. This method hence provides for a much higher quality of output from the receiver.

Though an exemplary system and method for reducing the jitter at a video display port receiver is described these are not meant to be limiting in any way. The method may be implemented with other high speed systems and processes, in the areas of high speed data transmission and other high speed applications where clock jitter is a concern. Such implementations and operations will be understandable to practitioners of the art. The application will enable the practitioners to overcome or reduce the jitter at the output by averaging the clock variations over time in high speed applications. Such implementations and improvements to the disclosed invention are all covered by this disclosure. Certain elements of this disclosure may be implemented in hardware, software, firmware or combinations thereof. Computer or computing capable device implementations of the method are also covered under this disclosure.

What is claimed is:

1. A method of reducing jitter in a recovered data stream clock the comprising:
receiving a stream of packetized video data, control information and special instructions over a high speed link with a link clock;
receiving a set of at least two integer values with said control information that provide the relationship between said link clock and the data stream clock used at the transmitter;
loading said at least two integers into an integer value adjuster circuit as its initial starting value;
enabling a first in first out (FIFO) memory to accept and retrieve unpacked video data,
said FIFO having at least a response level set for a high threshold value of unpacked video data stored, where said integer value adjuster circuit modifies values of at least one of said integers to decrement the data stream clock frequency recovered as the stored data crosses a high threshold level, and
said FIFO further having at least a response level set for low threshold value of unpacked video data stored where said integer value adjuster circuit modifies values of said integers to increment the data stream clock frequency as the stored data crosses a low threshold level;
recovering an initial value for the data stream clock frequency from said link clock using a video clock recovery circuit whose output frequency is modulated by said at least two integer values received;
unpacking video data from said video data packets using said data stream clock and loading said video data into a first in first out (FIFO) memory to an average preset level in said FIFO;
disconnecting said input of said video clock recovery circuit connected to at least two integers recovered from said high speed link and transferring said input to an output of said integer value adjuster circuit;
continuing to unpack and fill said FIFO with unpacked video data received using said data stream clock and further extracting and processing said unpacked video data from said FIFO at a rate defined by a need for said unpacked video data by a video receiver;
monitoring said response level set for said high threshold value, for unpacked video data in said FIFO, crossing said high threshold level and instructing said integer value adjuster circuit of such high threshold level crossing for modifying at least one of said integers to decrement data stream clock; and
monitoring said response level set for said low threshold, for unpacked video data in said FIFO crossing said low threshold level and instructing said integer value adjuster circuit of such low threshold level crossing for modifying at least one of said integers to increment said data stream clock;
such that the variations in said data stream clock are averaged over threshold levels in the FIFO, thereby eliminating sudden large variations and hence reducing the jitter in said recovered said data stream clock and a video output.

2. The method of claim 1 wherein said integer value adjuster circuit modifies values of both of said integers to decrement the data stream clock frequency recovered as the stored data crosses a high threshold level.

3. The method of claim 1, wherein the high speed link is a video display port link.

4. The method of claim 1, wherein the received stream is spread spectrum.

5. The method of claim 1, wherein the reduction of jitter in the recovered data stream clock improves the quality of the video receiver.

6. A system comprising:
a video clock recovery circuit that is able to regenerate a link clock from a reference clock input;
a ratio modulator M/N forming a part of said video clock recovery circuit enabled to modulate said regenerated link clock based on a pair of received integer values Mvid and Nvid that provide a relationship between said link clock with data packets and a data stream clock used for data unpacking;
a first in first out (FIFO) memory linked to said video clock recovery circuit and enabled to store unpacked data packets for use with at least one high data threshold level and at least one low data threshold level in the FIFO;
a monitor circuit linked to said FIFO for checking if said stored unpacked data level crosses said at least one high data threshold or at least one low data threshold;
a Mf and Nf value adjuster linked to said monitor circuit and enabled to incrementally adjust the value of at least one of said initial integers Mvid and Nvid that are received based on an input from said monitor circuit;
said monitor circuit further enabled to change an input into said ratio modulator M/N from said received value of Mvid and Nvid to an input from said Mf and Nf value adjuster;
said Mf and Nf value adjuster enabled to adjust the value of at least one of said integers to incrementally increase a frequency of the recovered data stream clock if said level of said stored unpacked data value drops below said at least one low data threshold to increase a rate of data unpacking and increase a rate that unpacked data is stored in said FIFO;
said Mf and Nf value adjuster further enabled to adjust the value of at least one of said integers to incrementally decrease a frequency of the recovered data stream clock if said level of stored unpacked data value increases above said at least one high data threshold, to decrease a rate of data unpacking and increase a rate that unpacked data is stored in said FIFO;
the system thereby being able to regenerate a data stream clock at a high speed data receiver that averages the instantaneous transitions in using the data storage in the FIFO to reduce the jitter in the recovered data stream clock.

7. The system of claim 6, wherein the Mf and Nf value adjuster is enabled to incrementally adjust the values of both of said initial integers Mvid and Nvid that are received based on an input from said monitor circuit.

8. The system of claim 6, wherein the high speed data receiver is a video display port receiver.

9. The system of claim 6, wherein the reduction of jitter in the recovered data stream clock improves the quality of the high speed data receiver.
